(19) United States
(12) Patent Application Publication
(10) Pub. No.: US 2004/0234078 A1
(43) Pub. Date: Nov. 25, 2004

(54) Method for automatically testing output audio signals

(76) Inventor: Rick Hsieh, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/849,910

(22) Filed: May 21, 2004

(30) Foreign Application Priority Data
May 23, 2003 (TW) 092113916

(51) Int. Cl. H04R 29/00

(52) U.S. Cl. 381/56; 375/224

(57) ABSTRACT

A method for automatically testing output audio signals is provided, s implementing in a codec. A S\PDIF of the codec outputs a digital audio signal and then a digital audio decoder converts the digital audio signal into an analog audio signal, wherein the analog audio signal is fed back to a Line In terminal of the codec so as to analyze the analog audio signal and determine whether the analog audio signal is correct.

### BACKGROUND OF THE INVENTION

1. Field of the Invention

The present invention generally relates to a method for automatically testing output audio signals, and more particularly, to a method for automatically testing audio signals output from a codec so as to reduce the testing time and cost.

2. Description of the Prior Art

In the state-of-the-art computer systems, audio sound is played by means of either additional sound boards or audio processors equipped on the motherboard. In any case, audio sound is reproduced by conversion of audio data into sound that human can hear. Generally, human ears are used to determine whether the reproduced audio sound is exactly the same as the original audio sound. Please refer to FIG. 1 which is a block diagram schematically illustrating a conventional method for automatically testing output audio signals in accordance with the prior art. As shown in FIG. 1, the audio signal processing procedure begins when the S\PDIF of a codec 10 outputs a digital audio signal and then the digital audio decoder 12 converts the digital audio signal into an analog audio signal. The analog audio signal is then played by a speaker 14 so that human ears 16 can hear it. During the audio signal processing procedure, the human ears 16 are used to determine whether the audio sound played by the speaker 14 matches the pre-determined audio signal. For example, in the testing procedure for a left channel, a right channel, and a center channel, the product is determined “OK” when the human cars 16 determines that the audio sound played by the speaker 14 matches the pre-determined audio signal; otherwise, the product is a failure.

However, the above testing method requires a great amount of labor power and thus lacks efficiency. Furthermore, the testing time and labor cost are and undesirably high.

Therefore, there is need in providing a method for automatically testing output audio signals, so as to reduce the testing time and cost.

### SUMMARY OF THE INVENTION

Accordingly, it is the primary object of the present invention to provide a method for automatically testing output audio signals, in Which a software program is used to determine whether the output audio signals are correct such that the required labor power during testing procedure can be reduced and the testing efficiency for mass production can be improved.

In order to achieve the foregoing and other objects, the present invention provides a method for automatically testing output audio signals, for use in a codec, wherein a S\PDIF of the codec outputs a digital audio signal and then a digital audio decoder converts the digital audio signal into an analog audio signal, wherein the analog audio signal is fed back to a Line In terminal of the codec so as to analyze the analog audio signal and determine whether the analog audio signal is correct.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a block diagram schematically illustrating a conventional method for testing output audio signals in accordance with the prior art;

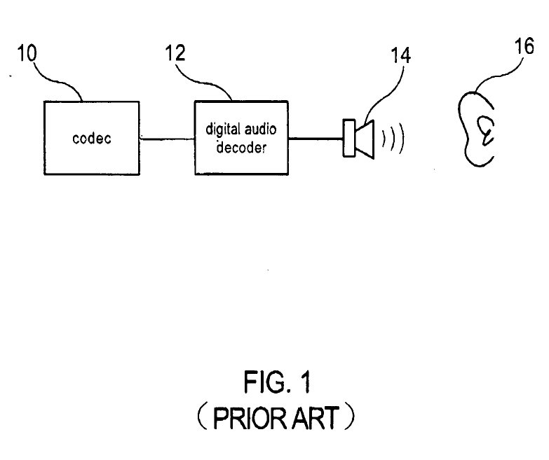

FIG. 2 is a block diagram schematically illustrating a method for automatically testing output audio signals in accordance with one preferred embodiment of the present invention;

FIG. 3 is a flow chart schematically illustrating a method for automatically testing output audio signals in accordance with one preferred embodiment of the present invention; and

FIG. 4 is a detailed flow chart of Step 320 in FIG. 3.

### DETAILED DESCRIPTION OF THE INVENTION

The present invention providing a method for automatically testing output audio signals can be exemplified by the preferred embodiments as described hereinafter.

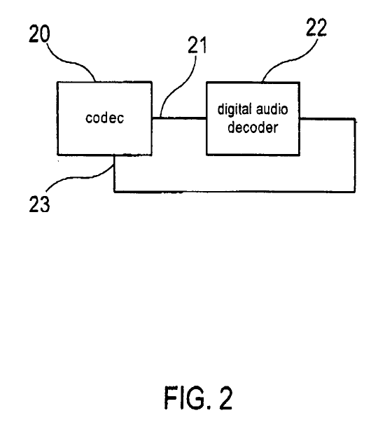

To start with, please refer to FIG. 2, which is a block diagram schematically illustrating a method for automatically testing output audio signals in accordance with one preferred embodiment of the present invention. As shown in the figure, a codec 20 comprises a S\PDIF 21 and a Line In terminal 23, wherein the S\PDIF 21 is connected to a digital audio decoder 22 and an output of the digital audio decoder 22 is fed back to the Line In terminal 23 of the codec 20. When the S\PDIF 21 of the codec 20 outputs a digital audio signal, the digital audio signal is converted by the digital audio decoder 22 into an analog audio signal, which is further fed back to and recorded by the Line In terminal 23 of the codec 20. Then a software program is used to analyze so as to determine whether the analog audio signal is correct, thus completing automatically testing.

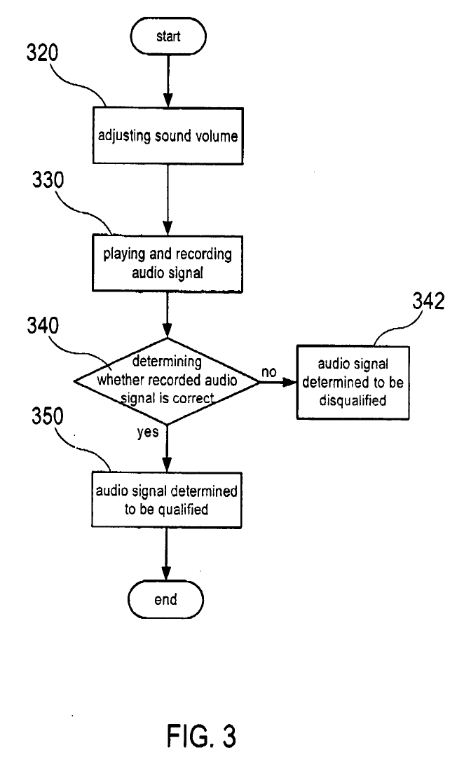

Please further refer to FIG. 3, which is a flow chart schematically illustrating a method for automatically testing output audio signals in accordance with one preferred embodiment of the present invention. In FIG. 3 and FIG. 2, the method for automatically testing output audio signals comprises steps as following:

Sound volume for the output of the codec 20 is adjusted to be with a proper range so as to confirm that the software program is able to analyze the recorded analog audio signal, as shown in Step 320.

The codec 20 plays a section of testing audio signals, which is decoded by the digital audio decoder 22 and then fed back to and recorded by the codec 20, as shown in Step 330.

A software program is used to analyze the analog audio signal and determine whether the recorded analog audio signal is the same as the pre-determined testing audio signal, as shown in Step 340.

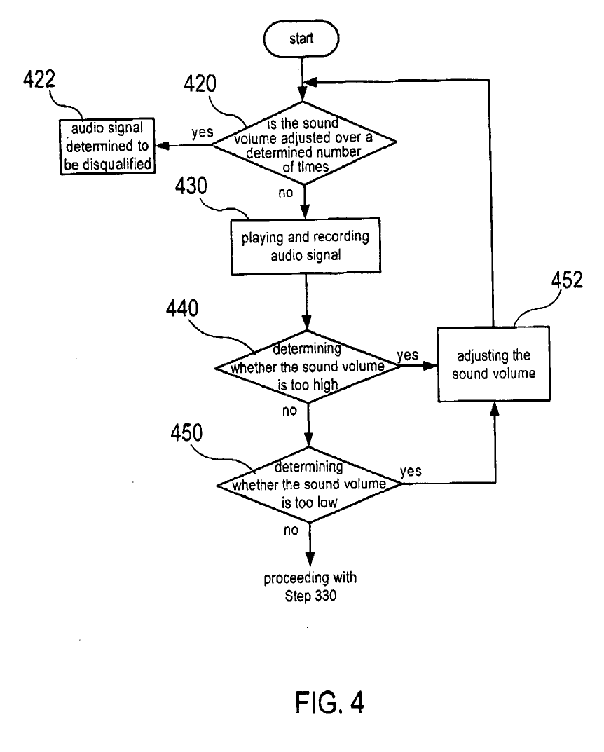

If the result of Step 340 is yes, the audio signal is determined to be qualified, as shown in Step 350; otherwise, the audio signal is determined to be disqualified, as shown in Step 342. Moreover, Step 320 is described in further detail accompanied with FIG. 4, which is a detailed flow chart of Step 320 in FIG. 3.

In FIG. 4 accompanied with FIG. 3 and FIG. 2, the codec 20 plays a section of testing audio signals, which is decoded by the digital audio decoder 22 and then fed back to and recorded by the codec 20, as shown in Step 430.

A software program is used to analyze the analog audio signal and determine whether the sound volume of the recorded analog audio signal is too high, as shown in Step 440. If the result of Step 440 is no, the procedure proceeds with Step 450 so as to determine whether the sound volume of the recorded analog audio signal is too low. If the result of Step 450 is no, the procedure proceeds with Step 330 so as to perform automatically testing output audio signals.

When the procedure goes on with Step 440 and Step 450, sound volume requires to be adjusted by using the digital audio decoder 22 if the sound volume of the recorded analog audio signal is too high or too low, as shown in Step 452. After the sound volume is adjusted, the sound volume is re-determined so as to see if the sound volume of the recorded analog audio signal is within a proper range. Therefore, an additional software program is required so as to determine whether the number of times the sound volume is adjusted over a determined number, such as five. If the number of times is no more than five, the procedure proceeds with Step 430, as shown in Step 420. However, if the number of times is more than five, the audio signal is determined to be disqualified, as shown in Step 422.

As a result according to the method for automatically testing output audio signals of the present invention, when a software program is used so as to automatically test output audio signals, labor power is only required for adjusting the sound volume. In other words, in Step 452 wherein the sound volume is adjusted by using the digital audio decoder 22, no further modification is required on the testing mechanism. The digital audio decoder 22 is operated by labor power, which bears no burden on determination.

According to the above discussion, it is apparent that the present invention discloses a method for automatically testing audio signals, in which a software program is used to determine the audio signal output from a codec so as to reduce the testing time and cost. Therefore, the present invention has been examined to be useful, novel and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

1. A method for automatically testing output audio signals, implemented in a codec, wherein a S\PDIF provided by said codec is connected to a digital audio decoder and said digital audio decoder is fed back to a Line In terminal provided by said codec, said method comprising steps of:
outputting a digital audio signal from said S\PDIF of said codec, said digital audio signal converted by said digital audio decoder into an analog audio signal, said analog audio signal further fed back to said codec;
recording said analog audio signal and analyzing said analog audio signal; and
determining whether said analog audio signal is correct, said analog audio signal determined to be qualified if yes, said analog audio signal determined to be disqualified otherwise.

2. The method for automatically testing output audio signals as claimed in claim 1, further comprising a step of:
adjusting sound volume of said analog audio signal within a proper range;

3. The method for automatically testing output audio signals as claimed in claim 2, wherein said step of adjusting sound volume of said analog audio signal within said proper range further comprising steps of:
determining whether the number of times said sound volume is adjusted over a determined number; said audio signal determined to be disqualified if yes;
determining whether said sound volume of said analog audio signal is too high; adjusting said sound volume if yes, proceeding with a next step otherwise; and
determining whether said sound volume of said analog audio signal is too low; adjusting said sound volume if yes.

4. The method for automatically testing output audio signals as claimed in claim 3, wherein said step of adjusting sound volume of said analog audio signal within said proper range is implemented by tester.

5. The method for automatically testing output audio signals as claimed in claim 3, wherein said determined number of times is a pre-determined value.

6. A method for automatically testing output audio signals, implemented in a codec, wherein a S\PDIF provided by said codec is connected to a digital audio decoder and said digital audio decoder is fed back to a Line In terminal of said codec, said method comprising steps of:
outputting a digital audio signal from said S\PDIF of said codec, said digital audio signal converted by said digital audio decoder into an analog audio signal, said analog audio signal further fed back to said codec;
recording said analog audio signal and adjusting sound volume of said analog audio signal within a proper range; and
further outputting a digital audio signal, said digital audio signal converted by said digital audio decoder into an analog audio signal, said analog audio signal further fed back to said codec;
further recording said analog audio signal and analyzing said analog audio signal; and
determining whether said analog audio signal is correct, said analog audio signal determined to be qualified if yes, said analog audio signal determined to be disqualified otherwise.

7. The method for automatically testing output audio signals as claimed in claim 6, wherein said step of adjusting sound volume of said analog audio signal within a proper range further comprising steps of;
determining whether the number of times said sound volume is adjusted over a determined number; said audio signal determined to be disqualified if yes, proceeding with a next step otherwise;
determining whether said sound volume of said analog audio signal is too high; adjusting said sound volume if yes, proceeding with a next step otherwise; and
determining whether said sound volume of said analog audio signal is too low; adjusting said sound volume if yes, determining said sound volume to be qualified otherwise.

8. The method for automatically testing output audio signals as claimed in claim 7, wherein said step of adjusting sound volume of said analog audio signal within said proper range is implemented by tester.

9. The method for automatically testing output audio signals as claimed in claim 7, wherein said determined number of times is a predetermined value.

10. A method for automatically testing output audio signals, implemented in a codec, wherein a S\PDIF provided by said codec is connected to a digital audio decoder and said digital audio decoder is fed back to a Line In terminal of said codec, said method comprising steps of:
outputting a digital audio signal from said S\PDIF of said codec, said digital audio signal converted by said digital audio decoder into an analog audio signal, said analog audio signal being further fed back to said Line In terminal of said codec;
determining whether said sound volume of said analog audio signal input into said codec is too high; adjusting said sound volume if yes, proceeding with a next step otherwise;
determining whether said sound volume of said analog audio signal input into said codec is too low; adjusting said sound volume if yes, determining said sound volume to be qualified otherwise;
outputting a digital audio signal, said digital audio signal converted by said digital audio decoder into an analog audio signal, said analog audio signal further fed back to said codec;
recording said analog audio signal and analyzing said analog audio signal; and
determining whether said analog audio signal is correct, said analog audio signal determined to be qualified if yes, said analog audio signal determined to be disqualified otherwise.

11. The method for automatically testing output audio signals as claimed in claim 10, wherein said step of determining whether said sound volume of said analog audio signal input into said codec is too high further comprises a step of:
re-determining said sound volume after adjusting said sound volume.

12. The method for automatically testing output audio signals as claimed in claim 11, wherein said determined number of times of said sound volume is a determinable value.

13. The method for automatically testing output audio signals as claimed in claim 10, wherein said step of determining whether said sound volume of said analog audio signal input into said codec is too low, further comprising a step of:
re-determining said sound volume after adjusting said sound volume.

14. The method for automatically testing output audio signals as claimed in claim 13, wherein said determined number of times of said sound volume is a determinable value.

15. The method for automatically testing output audio signals as claimed in claim 10, wherein said step of adjusting sound volume of said analog audio signal within said proper range is implemented by tester.
